(19) United States
(12) Patent Application Publication
(10) Pub. No.: US 2014/0170523 A1
(43) Pub. Date: Jun. 19, 2014

(54) ELECTRODE PASTE FOR SOLID OXIDE FUEL CELL, SOLID OXIDE FUEL CELL USING THE SAME, AND FABRICATING METHOD THEREOF

(71) Applicant: SAMSUNG ELECTRO-MECHANICS CO., LTD., Suwon (KR)

(72) Inventors: Bon Seok Koo, Suwon (KR); Jong Ho Chung, Suwon (KR); Sung Han Kim, Suwon (KR); Jong Sik Yoon, Suwon (KR)

(73) Assignee: SAMSUNG ELECTRO-MECHANICS CO., LTD., Suwon (KR)

(21) Appl. No.: 14/095,879

(22) Filed: Dec. 3, 2013

(30) Foreign Application Priority Data
Dec. 17, 2012 (KR) 10-2012-0147556

(51) Int. Cl. H01M 4/86; H01M 4/88; H01M 8/10

(52) U.S. Cl. CPC H01M 4/8605; H01M 8/1004; H01M 4/8885
USPC 429/474; 252/519.32; 252/519.33; 427/115

(57) ABSTRACT

Disclosed herein are an electrode paste for a solid oxide fuel cell in an anode supported type in which an anode, an electrolyte layer, and a cathode are sequentially stacked, including a raw material powder, a dispersant, a binder, a solvent, and a liquid pore-forming material, a solid oxide fuel cell using the same, and a fabricating method thereof. The electrode paste for the solid oxide fuel cell may form uniform pores in the electrode and may provide high porosity.

### CROSS REFERENCE TO RELATED APPLICATION

This application claims the benefit of Korean Patent Application No. 10-2012-0147556, filed on Dec. 17, 2012, entitled “Electrode Paste for Solid Oxide Fuel Cell, Solid Oxide Fuel Cell Using the Same, and Fabricating Method Thereof”, which is hereby incorporated by reference in its entirety into this application.

### BACKGROUND OF THE INVENTION

1. Technical Field

The present invention relates to an electrode paste for a solid oxide fuel cell, a solid oxide fuel cell using the same, and a fabricating method thereof.

2. Description of the Related Art

Fossil fuel widely used as a main energy source presently has a limitation in resources and as time passes, the resources thereof are depleted, an energy problem has become a nationally and socially big issue. Therefore, an interest in a fuel cell capable of generating energy including electricity from renewable energy sources such as petroleum, liquefied natural gas (LNG), liquefied petroleum gas (LPG), and hydrogen has increased.

The fuel cells are devices directly converting chemical energy of the fuel to electrical energy through an electrochemistry reaction, and among them, a solid oxide fuel cell (SOFC) has recently received a lot of attention due to excellent conversion efficiency and usability of various fuels, and research into a technology for commercializing the SOFC for home use or for power generation use has been actively conducted based on a gas company and an electric power company.

The solid oxide fuel cell is configured of an electrolyte layer which has an oxygen ionic conductivity and is densely formed, and a porous cathode (or which is referred to as an “air electrode”) and an anode (or which is referred to as a “fuel electrode”) positioned on both surfaces of the electrolyte layer. In describing an operating principle, oxygen is penetrated through the porous cathode to arrive at the electrolyte surface, and oxygen ions produced by a reduction reaction of the oxygen are moved to an anode through the densified electrolyte and are reacted again with hydrogen supplied into the porous anode, such that water is produced, wherein since electrons are produced in the anode and electrons are consumed in the cathode, in the case in which the anode and the cathode are connected to each other, electricity is generated.

In order to commercialize the solid oxide fuel cell as described above, cost reduction and improved durability of the cell should be achieved, and to do this, it is important to increase performance of a unit cell to thereby decrease the number of cells used in a stack.

In order to increase the performance of the unit cell, it is required to improve electrical conductivity of a material and maintain raw materials and air to be smoothly supplied through is an electrode in a fine structure, having high porosity, such that overpotential of the electrode should be decreased, which is the most important factor.

In the prior art, carbon black or graphite has been mainly used as a pore-forming material for increasing a porosity in an electrode of the solid oxide fuel cell as described in Patent Document 1; however, organic pore-forming materials such as carbon black and graphite have several disadvantages in being applied as a pore-forming material for an electrode of the SOFC.

First, the carbon black and graphite have a difference in grain sizes by 30 times or more as compared to particles of the cathode or the anode and has a distribution of the grain size of 0.1 to 100 μm or more, that is, the particles are extremely and widely distributed (see FIGS. 1 and 2). Second, an added amount of the pore-forming material should be increased in order to increase the porosity; however, in the case of the carbon black, since an aggregation between the pore-forming materials easily occurs, it is difficult to obtain a uniform pore structure (see FIG. 3), and in addition, in the case in which the pore-forming material is added in an amount of 10 wt % or more, a thickness of a coating film is increased due to an increase in a density of a slurry, and therefore, at the time of performing a drying process and a sintering process as subsequent processes, the coating film is peeled (see FIG. 4).

### PRIOR ART DOCUMENT

### Patent Document

Patent Document 1 Korean Patent Laid-Open Publication No. KR 2005-004996

### SUMMARY OF THE INVENTION

In the present invention, a liquid pore-forming material is used to improve a porosity in an electrode of a solid oxide fuel cell, thereby solving the existing problems and completing the present invention.

Therefore, the present invention has been made in an effort to provide an electrode paste for the solid oxide fuel cell capable of forming uniform pores in the electrode of the solid oxide fuel cell and providing high porosity.

In addition, the present invention has been made in an effort to provide a fabricating method of a solid oxide fuel cell using the electrode paste for the solid oxide fuel cell.

Further, the present invention has been made in an effort to provide a solid oxide fuel cell having high porosity fabricated by using the fabricating method.

According to a preferred embodiment of the present invention, there is provided an electrode paste for a solid oxide fuel cell in an anode supported type in which an anode, an electrolyte layer, and a cathode are sequentially stacked, including a raw material powder, a dispersant, a binder, a solvent, and a liquid pore-forming material.

The pore-forming material may be a glycol-based organic solvent or a paraffin-based organic solvent having a boiling point of 120° C. or more and a molecular weight of 180 or less.

The paste may include the raw material powder in an amount of 10 to 90 wt %, the dispersant in an amount of 0.2 to 5 wt %, the binder in an amount of 1 to 20 wt %, the solvent in an amount of 5 to 70 wt %, and the liquid pore-forming material in an amount of 1 to 35 wt %.

The glycol-based organic solvent may be ethylene glycol or propylene glycol, and the paraffin-based organic solvent may be mineral spirit.

The raw material powder in the anode may be NiO—YSZ, NiO—ScSZ or NiO-GDC, the raw material powder in the cathode may be lanthanum-strontium-manganese oxide (LSM), lanthanum-strontium-cobalt-ferrite oxide (LSCF), or lanthanum-strontium-cobalt-manganese oxide (LSCM), the dispersant may be a phosphate-based dispersant, or alpha-terpineol (α-terpineol), the binder may be ethyl cellulose or polyvinyl butyral (PVB), and the solvent may be isopropyl alcohol, ethyl alcohol, toluene or mixtures of two kinds thereof.

According to another preferred embodiment of the present invention, there is provided a fabricating method of a solid oxide fuel cell, the fabricating method including: applying a paste including a raw material powder, a dispersant, a binder, a solvent, and a liquid pore-forming material to form an anode support; forming an electrolyte layer on the anode support; firing a structure including the anode support and the electrolyte layer; and forming a cathode on the electrolyte layer and performing a firing process.

The liquid pore-forming material may be a glycol-based organic solvent or a paraffin-based organic solvent having a boiling point of 120° C. or more and a molecular weight of 180 or less.

The paste may include the raw material powder in an amount of 10 to 90 wt %, the dispersant in an amount of 0.2 to 5 wt %, the binder in an amount of 1 to 20 wt %, the solvent in an amount of 5 to 70 wt %, and the liquid pore-forming material in an amount of 1 to 35 wt %.

The glycol-based organic solvent may be ethylene glycol or propylene glycol, and the paraffin-based organic solvent may be mineral spirit.

The raw material powder in the anode may be NiO—YSZ, NiO—ScSZ or NiO-GDC, the raw material powder in the cathode may be lanthanum-strontium-manganese oxide (LSM), lanthanum-strontium-cobalt-ferrite oxide (LSCF), or lanthanum-strontium-cobalt-manganese oxide (LSCM), the dispersant may be a phosphate-based dispersant, or alpha-terpineol (α-terpineol), the binder may be ethyl cellulose or polyvinyl butyral (PVB), and the solvent may be isopropyl alcohol, ethyl alcohol, toluene or mixtures of two kinds thereof.

According to another preferred embodiment of the present invention, there is provided a solid oxide fuel cell fabricated by the fabricating method as described above, including: a porous anode support having a thickness of 0.4 to 1 mm; an electrolyte layer having a thickness of 5 to 20 μm; and a porous cathode having a thickness 10 to 80 μm, wherein the porous anode support, the electrolyte layer, and the porous cathode are sequentially stacked, and the electrode has a porosity of 10% to 30%.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an electron microscope photograph showing a fine structure of a carbon black used as the existing pore-forming material for an electrode of a solid oxide fuel cell;

FIG. 2 is a graph showing a grain size distribution of the carbon black used as the pore-forming material for the electrode of the solid oxide fuel cell, wherein a horizontal axis indicates a grain size, a vertical axis indicates frequency of the particle, and an abbreviation LSM shown in introductory notes means a lanthanum-strontium-manganese oxide (La—Sr—Mn oxide);

FIG. 3 is an electron microscope photograph showing a fine structure of an electrode of a solid oxide fuel cell, wherein the electrode is fabricated by using carbon black in 8 wt % as the existing pore-forming material;

FIG. 4 is a photograph showing an external appearance of an electrode fabricated by using carbon black in 10 wt % as the existing pore-forming material to coat the electrode of the solid oxide fuel cell;

FIG. 5 is a schematic view showing an operating principle forming an electrode of a solid oxide fuel cell having a porosity, fabricated by using a liquid pore-forming material according to a preferred embodiment of the present invention;

FIGS. 6A to 6D are electron microscope photographs showing a fine structure of an electrode paste sheet for the solid oxide fuel cell according to an added amount of the liquid pore-forming material according to a preferred embodiment of the present invention; and

FIG. 7 is a view schematically showing a device measuring an air permeability of the electrode paste sheet for the solid oxide fuel cell having the liquid pore-forming material added thereto according to the preferred embodiment of the present invention.

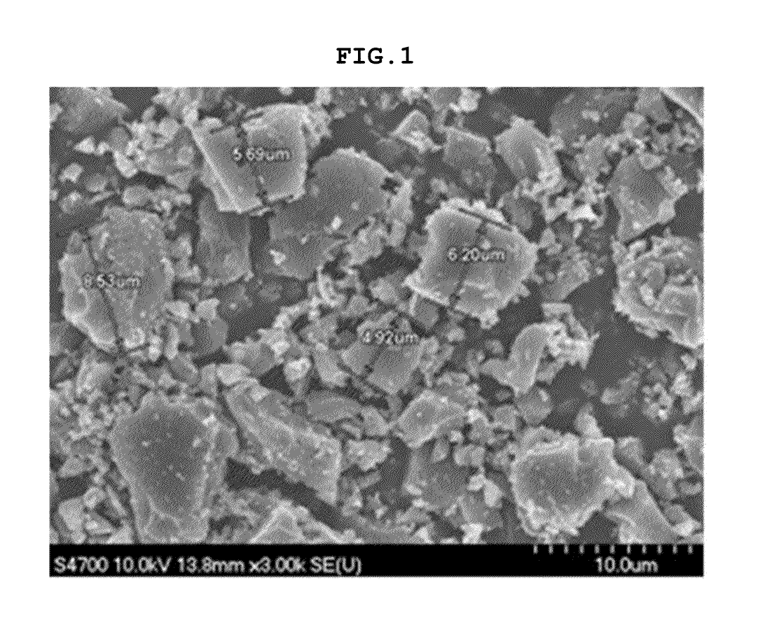

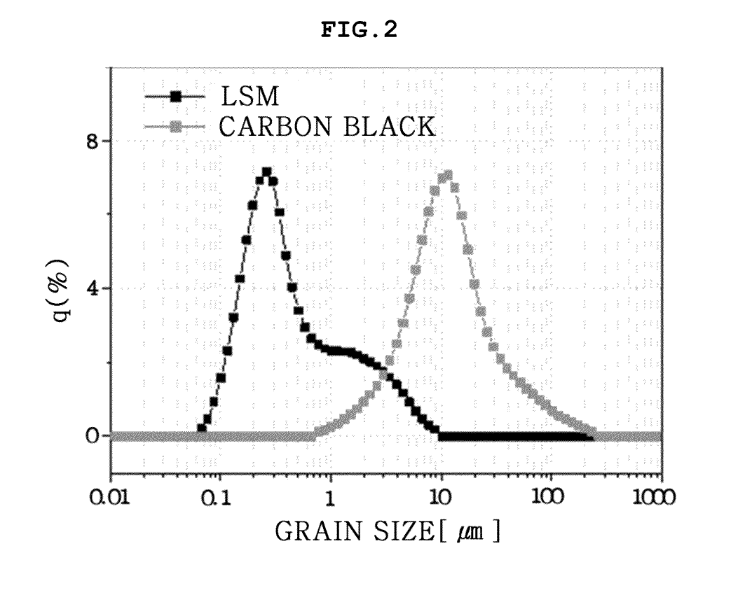

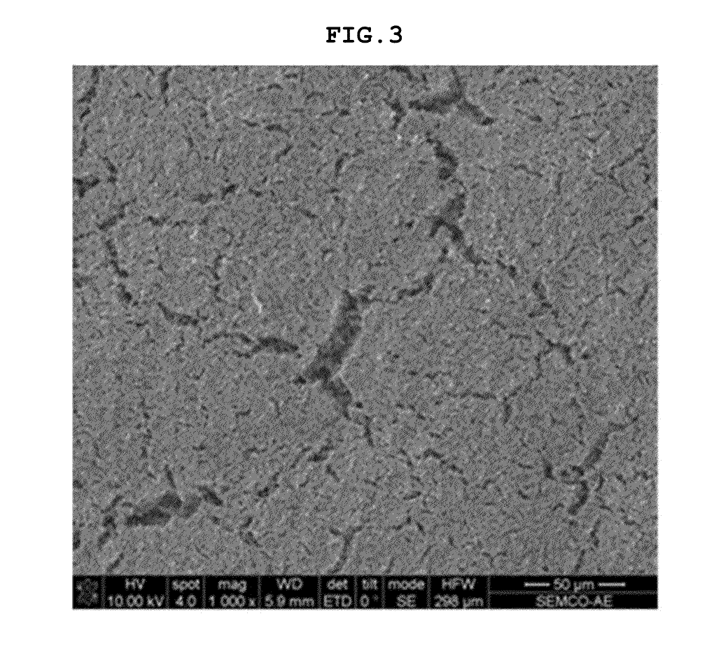

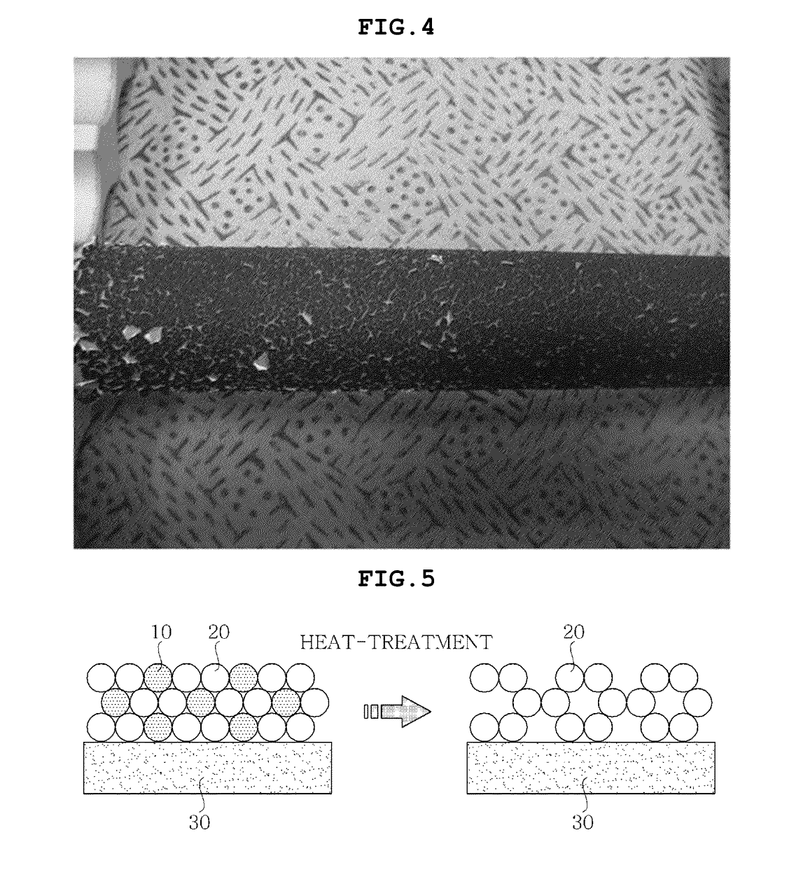

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

In general, zirconia (ZrO₂) has been used as an electrolyte in a solid oxide fuel cell, and in recent years, yttria stabilized zirconia (YSZ), that is, a stabilized zirconia having a doped yttria (Y₂O₃) has been largely used, and various kinds thereof has been developed depending on a unit cell, a stack, and an operating temperature. The unit cell is classified into an electrolyte-supported cell and an electrode-supported cell according to a structural support, wherein the electrode-supported cell includes a cathode-supported cell and an anode-supported cell.

The anode-supported unit cell has a structure in which an anode-functional layer, an electrolyte layer, and a cathode layer are sequentially formed on an anode substrate. Since a surface defect of a porous anode is connected with a defect of the electrolyte in a fabricating method of the anode-supported unit cell, it is important to appropriately control a pore structure of the anode and to suppress a coarse surface defect.

As described above, the porous anode fabricated by using solid-phase particles and polymer particles as a pore-forming material has pore diameters with double or triple distribution, and in the case of using the pore-forming material such as graphite, anisotropy in a pore shape is generated to increase a processing defect generation in the electrolyte layer. The coarse pores produced by the multiplicity in the pore diameter distribution or the anisotropy in the structure cause the electrolyte layer subsequently formed in the anode by a screen printing method to be depressed or to be cracked, such that a fabrication yield and performance of the unit cell are deteriorated.

Another processing defect generated in fabricating a unit cell having a large area is a peel or a crack generated between the layers configuring the cell, wherein due to the interface defect, resistance of the unit cell is increased to rapidly deteriorate the performance and resistance with respect to heat stress is remarkably weaken.

The interface defect as described above is generated by a difference between a sintering shrinkage or a difference between coefficient of thermal expansion between the layers configuring the cell, and in the case in which an interface strength is weak, the size of the defect is increased to deteriorate the fabrication yield and the unit cell has deteriorated performance at the time of being operated, and in the case in which the heat-stress is applied, the unit cell has remarkably decreased durability. The interface defect in the unit cell of the solid oxide fuel cell is mainly resulted from a structural defect on a surface of an anode, a charging non-uniformity of the anode-functional layer or the electrolyte layer that are thick films subsequently formed by a screen printing method, and a lower interface strength of the cathode layer having an inclined function structure (that is, a structure provided with a pore gradient in a fine structure, and for example, a structure in which a porosity of the electrode becomes decreased from an outer side to an inner side).

In the preferred embodiment of the present invention, the above-described problems are overcome by using a liquid pore-forming material. In general, a slurry for forming the electrode of the fuel cell includes a raw material powder, a dispersant, a binder, and an organic solvent, wherein a pore-forming material for forming pores is further included therein. The preferred raw material powder in the anode according to the preferred embodiment of the present invention is NiO—YSZ, NiO—ScSZ, NiO-GDC, or the like, and the preferred raw material powder in the cathode is lanthanum-strontium-manganese oxide (LSM), lanthanum-strontium-cobalt-ferrite oxide (LSCF), lanthanum-strontium-cobalt-manganese oxide (LSCM), or the like. Examples of the dispersant include a phosphate-based dispersant (commercially available as trade name: BYK 180, BYK 2155, and the like), alpha-terpineol (α-terpineol), and the like, and examples of the binder include ethyl cellulose, polyvinyl butyral (PVB), and the like, but the present invention is not limited thereto. In addition, it is preferred that the solvent is isopropyl alcohol, ethyl alcohol, toluene or mixtures of two kinds thereof.

According to the preferred embodiment of the present invention, in the case in which the above-described components are mixed with together, a slurry having a low viscosity or a paste having a high viscosity may be formed mainly depending on a used amount of the raw material powder or the solvent. However, according to needs for explaining and/or describing the present invention, both of the slurry and the paste are used without differentiation, and in particular, the “paste” is mainly used.

In the case of using the slurry or the paste to form the electrode by a dip-coating, a tape-casting, or a screen-printing, the organic solvent is volatilized through coating and drying processes and the raw material powder and the pore-forming material are only left.

Then, in the case in which the pore-forming material is removed by calcinating and firing processes, a space filled with the pore-forming material becomes an empty space, such that pores are formed in the electrode. As the pore-forming material having the above-described usage, carbon-based compounds such as carbon black and graphite are mainly used, but have a large distribution of the grain size to have difficulty in achieving the uniform distribution, and have a limitation in an added amount to have limitation in increasing the porosity. In addition, the carbon-based compound is difficult to be removed by the calcinating process and has defects caused by residual carbon.

Meanwhile, the liquid pore-forming material has compatibility with the organic solvent used in the slurry to easily achieve uniform dispersion, and since the liquid pore-forming material is in a liquid-state, there is no limitation in the added amount that the liquid pore-forming material is capable of being added, and therefore, the liquid pore-forming material has an advantageous effect in improving the porosity. However, the liquid pore-forming material known throughout the industry, for example, poly ethylene glycol, poly tetramethylene glycol, poly acrylic acid, polyvinyl alcohol, and polypropylene glycol function as the pore-forming material, and as a plasticizer decreasing a glass transition temperature of a hydrocarbon-based binder. Therefore, in the case in which the above-described components are added in an excessive amount, the binder has decreased physical property and the shape of the sheet may not be maintained or may be changed. Therefore, an example to which the liquid pore-forming material is applied as the pore-forming material of an electrode paste for the solid oxide fuel cell did not exist.

However, according to the preferred embodiment of the present invention, a glycol-based organic solvent or a paraffin-based organic solvent having a boiling point of 120° C. or more and a molecular weight of 180 or less is applied as the liquid pore-forming material, such that uniform dispersion and high porosity may be achieved without deterioration in the physical properties of the binder. The preferred examples of the glycol-based organic solvent according to the preferred embodiment of the present invention include ethylene glycol or propylene glycol, and the preferred examples of the paraffin-based organic solvent include mineral spirit, and the like.

In an operating principle at the time of applying the liquid pore-forming material according to the preferred embodiment of the present invention, with reference to FIG. 5, in the case of a solvent having a high boiling point, such as ethylene glycol, mineral spirit, and the like, as the liquid pore-forming material 10, the boiling point is 120° C. or more, such that after being coated on a substrate 30, the material is not removed in the drying process and left on the coating film 20 to maintain pores. In addition, the material has a molecular weight of 180 or less which is relatively lower than that of the known liquid pore-forming material in the other field to be easily removed without remaining materials through the calcinating and firing processes, such that pores are uniformly formed in the electrode.

According to the preferred embodiment of the present invention, at the time of mixing main raw materials configured by including the raw material powder in an amount of 10 to 90 wt % containing a nickel oxide ceramix powder and an yttria stabilized zirconia powder in a molar ratio of 8 to 10% and the liquid pore-forming material in an amount of 1 to 35 wt %, organic additives such as an organic binder in an amount of 1 to 20 wt % and a dispersant in an amount of 0.2 to 5 wt % are secondarily added thereto, and the reactant is mixed in a solvent in an amount of 5 to 70 wt %, and molded to form an electrode mold body. Then, the molded body is fat-removed through a heat treatment, the organic additive is removed, and a sintering process is fired at a higher temperature. Here, in the case in which the added amount of the liquid pore-forming material is less than 1 wt %, effects obtained by the added amount are hardly shown, and in the case in which the added amount of the liquid pore-forming material is more than 35 wt %, the electrode has a weaken mechanical strength. Other components except for the liquid pore-forming material are determined depending on usage purposes within the scope used by a person skilled in the art.

When specifically describing the preferred embodiment of the present invention according to the above-described method, ethylene glycol is firstly added to the raw material powder configured by including the nickel oxide ceramix powder and the 8% yttria stabilized zirconia powder that are main components of the raw material in the anode of the solid oxide fuel cell. A slurry obtained by mixing the binder (for example, a thermosetting resin and a thermoplastic resin) and the dispersant in presence of a solvent (alcohol or acetone-based solvent) is sprayed to a non-solvent having a non-solubility or a partial solubility with respect to the binder, and dried at a temperature of 70° C. or less, thereby fabricating granules that the raw material powder, the binder and the liquid pore-forming material have the uniform distribution. The granules have nearly spherical shapes and maintained sizes of 50 to 100 μm, which may minimize non-uniformity of the substrate generated in a molding process using thermal curing. The fabricated granules are dried at a temperature of about 70° C. or less, and a molding process using thermal curing is performed at a temperature range of 90 to 120° C., thereby obtaining a plate anode support having a thickness of about 0.5 to 1 mm.

After the electrolyte layer having a thickness of 5 to 30 μm is formed on the porous anode support by general methods such as the screen printing method, a sintering process is performed at a temperature of about 1,400° C., and a porous cathode having a thickness of 30˜80 μm is formed on the electrolyte layer by the screen printing method, and the like. Then, a firing process is performed at a temperature of about 1,100° C. to obtain an anode-electrolyte-cathode in a multilayer structure. The electrode has a porosity in a range of 10 to 30%.

Hereinafter, the preferred embodiments of present invention will be described in more detail with reference to the following example; however, the scope of the present invention is not limited thereto.

### EXAMPLE 1

A raw material powder containing a nickel oxide powder and 8% yttria stabilized zirconia mixed in a 6:4 weight ratio was mixed with ethylene glycol as a pore-forming material in an amount of 0 to 20 wt %, and with respect to 100 parts by weight of the above-fabricated mixture, PVB in an amount of 10 parts by weight as a binder, dioctyl phthalate in an amount of 4 parts by weight as a plasticizer, and BYK 2155 in an amount of 2 parts by weight as a dispersant were mixed with together, and then the mixture was wet-mixed in a solvent fabricated by mixing toluene and ethanol in 5:5 ratio.

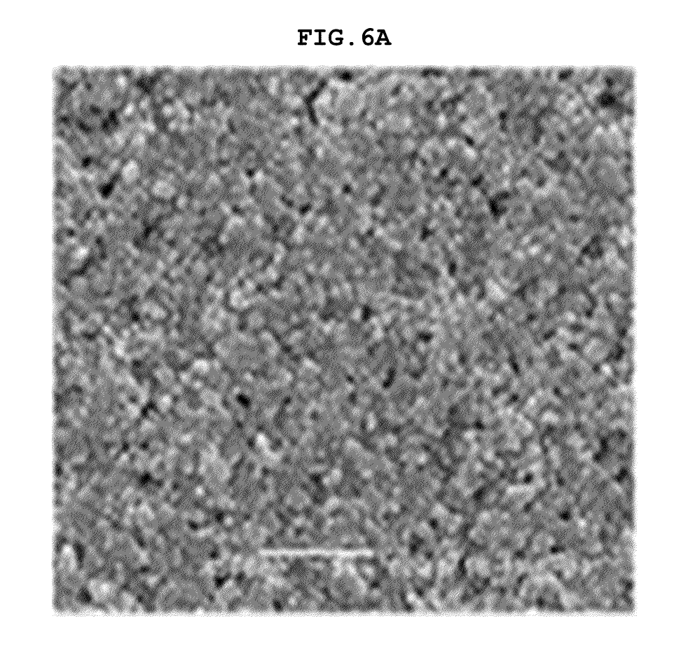

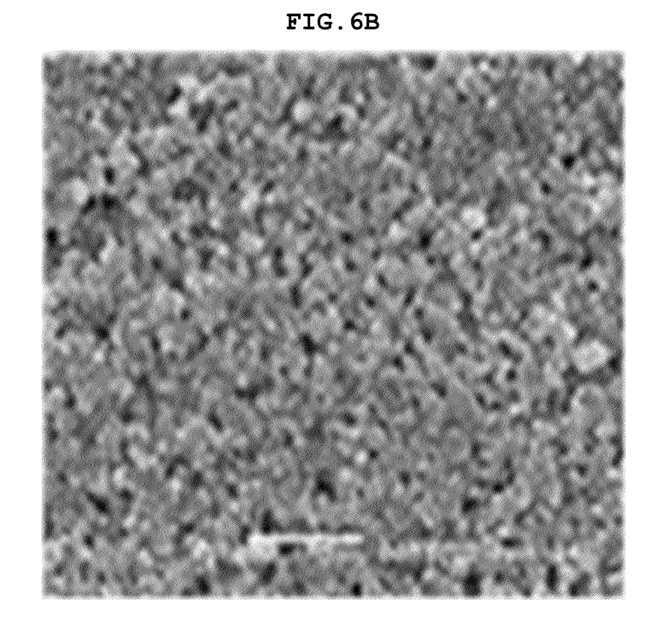

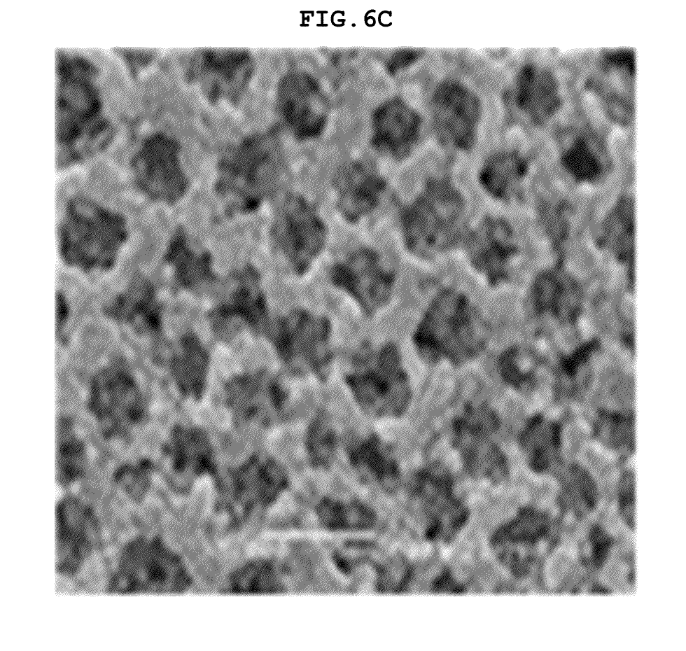

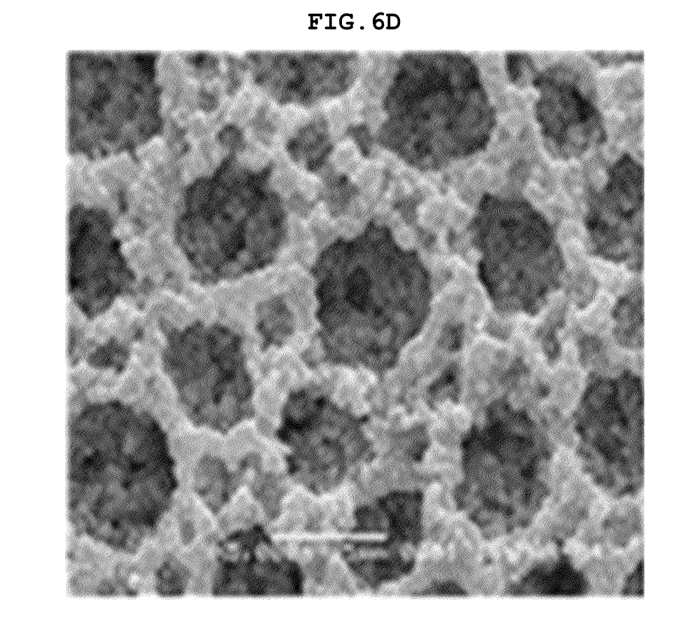

The wet-mixture was fabricated so as to be in a sheet having a thickness of 35 to 50 μm using a tape casting method, and a pore structure and a ventilation degree of the fabricated sheet were measured. The pore structure of the sheet was shown in FIGS. 6A to 6D, and the ventilation degree of the sheet is shown in the following Table 1. FIG. 6A shows a case in which the liquid pore-forming material is not added (0 wt %), FIG. 6B shows a case in which the liquid pore-forming material in an amount of 5 wt % is added, FIG. 6C shows a case in which the liquid pore-forming material in an amount of 10 wt % is added, and FIG. 6D shows a case in which the liquid pore-forming material in an amount of 20 wt % is added.

TABLE 1

| | Added Amount of Liquid Pore-Forming Material | | | |
|---|---|---|---|---|
| | 0 wt % | 5 wt % | 10 wt % | 20 wt % |
| Air Permeability (sec) | 365 | 200 | 132 | 48 |

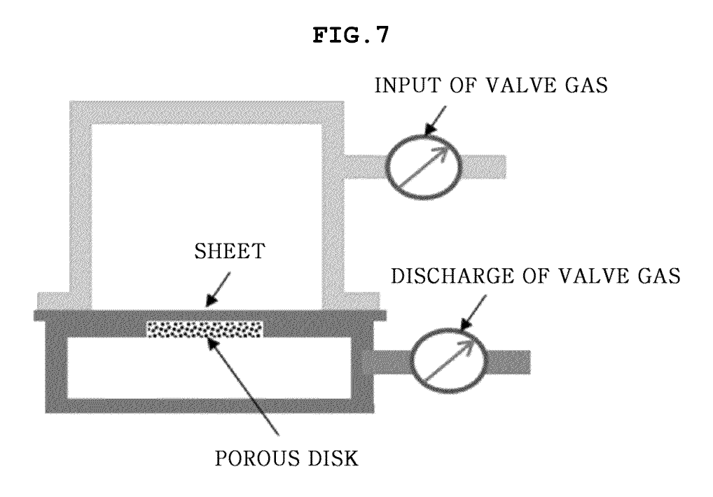

The air permeability was measured as shown in a device of FIG. 7 by firstly putting one sheet on a porous disk installed at the center in a lower portion of a closed container, covering an upper container so that a gas is not leaked into an end of the sheet, and coupling tightly with each other to be closed. Then, nitrogen was used in the pressure container to measure a time when a predetermined pressure (for example, 2 pressure) was decreased.

It may be appreciated from Table 1 above and FIG. 6 that the liquid pore-forming material is added to thereby increase electrode porosity after performing a sintering process, and as a result obtained by measuring air permeability of the sheet in order to evaluate how many pores were formed in the molded sheet, in the case in which the liquid pore-forming material in an amount of 20 wt % is added, the air permeability was decreased by 1/9, that is, air permeability at an initial stage was 356 sec and was decreased to be 48 sec. The above-described effects may be obtained as the same as in a glycol-based organic solvent and mineral spirit, having a boiling point of 120° C. or more and a molecular weight of 180 or less as well as in ethylene glycol.

As set forth above, the electrode paste for the solid oxide fuel cell according to the preferred embodiment of the present invention may include the liquid pore-forming material to form the uniform pores in the electrode and the existing carbon-based compound has a limitation in an added amount to the paste (in general, the added amount is less than 10 wt %), to have difficulty in obtaining the high porosity. However, according to the preferred embodiment of the present invention, the liquid pore-forming material does not have a limitation in the added amount, such that the electrode having high porosity may be fabricated.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An electrode paste for a solid oxide fuel cell in an anode supported type in which an anode, an electrolyte layer, and a cathode are sequentially stacked, comprising a raw material powder, a dispersant, a binder, a solvent, and a liquid pore-forming material.

2. The electrode paste for a solid oxide fuel cell as set forth in claim 1, wherein the liquid pore-forming material is a glycol-based organic solvent or a paraffin-based organic solvent having a boiling point of 120° C. or more and a molecular weight of 180 or less.

3. The electrode paste for a solid oxide fuel cell as set forth in claim 1, wherein the paste includes the raw material powder in an amount of 10 to 90 wt %, the dispersant in an amount of 0.2 to 5 wt %, the binder in an amount of 1 to 20 wt %, the solvent in an amount of 5 to 70 wt %, and the liquid pore-forming material in an amount of 1 to 35 wt %.

4. The electrode paste for a solid oxide fuel cell as set forth in claim 2, wherein the glycol-based organic solvent is ethylene glycol or propylene glycol, and the paraffin-based organic solvent is mineral spirit.

5. The electrode paste for a solid oxide fuel cell as set forth in claim 1, wherein the raw material powder in the anode is NiO—YSZ, NiO—ScSZ or NiO-GDC, the raw material powder in the cathode is lanthanum-strontium-manganese oxide (LSM), lanthanum-strontium-cobalt-ferrite oxide (LSCF), or lanthanum-strontium-cobalt-manganese oxide (LSCM), the dispersant is a phosphate-based dispersant, or alpha-terpineol (α-terpineol), the binder is ethyl cellulose or polyvinyl butyral (PVB), and the solvent is isopropyl alcohol, ethyl alcohol, toluene or mixtures of two kinds thereof.

6. A fabricating method of a solid oxide fuel cell, the fabricating method comprising:
applying a paste including a raw material powder, a dispersant, a binder, a solvent, and a liquid pore-forming material to form an anode support;
forming an electrolyte layer on the anode support;
firing a structure including the anode support and the electrolyte layer; and
forming a cathode on the electrolyte layer and performing a firing process.

7. The fabricating method as set forth in claim 6, wherein the liquid pore-forming material is a glycol-based organic solvent or a paraffin-based organic solvent having a boiling point of 120° C. or more and a molecular weight of 180 or less.

8. The fabricating method as set forth in claim 6, wherein the paste includes the raw material powder in an amount of 10 to 90 wt %, the dispersant in an amount of 0.2 to 5 wt %, the binder in an amount of 1 to 20 wt %, the solvent in an amount of 5 to 70 wt %, and the liquid pore-forming material in an amount of 1 to 35 wt %.

9. The fabricating method as set forth in claim 7, wherein the glycol-based organic solvent is ethylene glycol or propylene glycol, and the paraffin-based organic solvent is mineral spirit.

10. The fabricating method as set forth in claim 6, wherein the raw material powder in the anode is NiO—YSZ, NiO—ScSZ or NiO-GDC, the raw material powder in the cathode is lanthanum-strontium-manganese oxide (LSM), lanthanum-strontium-cobalt-ferrite oxide (LSCF), or lanthanum-strontium-cobalt-manganese oxide (LSCM), the dispersant is a phosphate-based dispersant, or alpha-terpineol (α-terpineol), the binder is ethyl cellulose or polyvinyl butyral (PVB), and the solvent is isopropyl alcohol, ethyl alcohol, toluene or mixtures of two kinds thereof.

11. A solid oxide fuel cell fabricated by the fabricating method as set forth in claim 6, comprising:
a porous anode support having a thickness of 0.4 to 1 mm;
an electrolyte layer having a thickness of 5 to 20 μm; and
a porous cathode having a thickness 10 to 80 μm,
wherein the porous anode support, the electrolyte layer, and the porous cathode are sequentially stacked, and
the electrode has a porosity of 10% to 30%.
